(19) United States
(12) Patent Application Publication
(10) Pub. No.: US 2002/0112071 A1
(43) Pub. Date: Aug. 15, 2002

(54) System and method for exchanging online information along optimum path

(76) Inventor: Jae Hoon Kim, Seoul (KR)

Correspondence Address: BIRCH STEWART KOLASCH & BIRCH, PO BOX 747, FALLS CHURCH, VA, 22040-0747, US

(21) Appl. No.: 09/888,520

(22) Filed: Jun. 26, 2001

(30) Foreign Application Priority Data
Feb. 10, 2001 (KR) 2001-6574

(51) Int. Cl. G06F 15/173; G06F 15/16

(52) U.S. Cl. 709/238; 709/230

(57) ABSTRACT

A system and method for exchanging online information along an optimum path in a client/server system which includes a client having a plurality of Internet protocol (IP) addresses for sending and receiving the online information over an Internet network, and a server connected to the client via a router. Where the client employs a plurality of IP addresses over a private network and desires to exchange the online information with the server, it sends information about the employed IP addresses to the server and then detects an IP address providing the optimum path for access to the server in response to acknowledgement information from the server. Therefore, the client can send and receive the online information to/from the server along the optimum path, resulting in an increase in information exchange rate and an improvement in the quality of the online information.

### BACKGROUND OF THE INVENTION

1. Field of the Invention

The present invention relates in general to the exchange of online information along an optimum path, and more particularly to a system and method for exchanging online information along an optimum path, wherein a client that has a plurality of Internet protocol addresses and desires to exchange the online information with a server can send and receive the online information to/from the server along the optimum path.

2. Description of the Prior Art

Recently, the number of Internet users has rapidly increased, resulting in a shortage of Internet protocol (referred to hereinafter as IP) addresses. In order to solve such a shortage of Internet protocol addresses and enable accesses of a larger number of persons to an Internet network, there have been proposed private IP addresses, which have been often used for additional applications such as security and load balancing.

Because such a private IP address is unique only in a private network, it must be translated into a public IP address to enable an associated client to gain access to a server over an Internet network connected to a public network. The translation of a private IP address into a public IP address is typically called a network address translation (referred to hereinafter as NAT).

Provided that a client desiring to use online information over the Internet network employs not a public IP address, but a private IP address, a router acting to route the client to a server with a public IP address performs the NAT function to translate the private IP address employed by the client into a public IP address for access of the client to the server providing information desired by the client.

The NAT may generally be classified into a static NAT and a dynamic NAT according to methods for translating a private IP address into a public IP address. Masquerading may be a special dynamic NAT.

The static NAT is applied to the case where private IP addresses are the same in number as public IP addresses. That is, the static NAT is adapted to translate private IP addresses into public IP addresses at one-to-one regular intervals, as shown in FIG. 1. In FIG. 1, a server S1 with a public IP address ‘203.245.37.101’ is shown to exchange online information with a client C1 whose private IP address ‘165.133.82.91’ is translated into a public IP address ‘210.99.105.91’ by the NAT function of a router R1.

The dynamic NAT is applied to the case where private IP addresses are greater in number than public IP addresses. Namely, the dynamic NAT is adapted to assign public IP addresses dynamically to private IP addresses, as shown in FIG. 2. In FIG. 2, a server S2 with a public IP address ‘203.245.37.101’ is shown to exchange online information with a client C2 whose private IP address ‘165.133.82.91’ is translated into a public IP address ‘210.99.105.91’ by the NAT function of a router R2 upon accessing the server S2.

Accordingly, a public IP address assigned dynamically to a private IP address is significant only when a client and server are kept connected to each other. Provided that the connection between the server and client is released, it will be impossible to gain access to the client using the public IP address assigned to the client. In this regard, the dynamic NAT function is often used in association with security related functions.

The masquerading function is applied to the case where one public IP address is employed, as shown in FIG. 3. For connection of a plurality of clients with private IP addresses to an external server via one public IP address, port numbers are assigned respectively to the clients in addition to the public IP address, such that the plurality of private IP addresses are mapped to the single public IP address. In FIG. 3, a server S3 with a public IP address ‘203.245.37.101’ is shown to exchange online information with a client C3 whose private IP address ‘165.133.82.91’ is translated into a number of a 5000^{th} port of a public IP address ‘210.99.105.91:5000’ by the NAT function of a router R3.

At the present time, many clients have increasingly employed two or more IP addresses with the aid of the above-stated NAT function with the use of one or more local area network (LAN) cards or modems for various purposes.

Such a client with two or more IP addresses typically communicates with a server using one of those IP addresses, accessible to the server. However, any one of such IP addresses is generally set as a default in an operating system (OS) of the client, such as Windows, etc., so the client can communicate with the server using only the set IP address. This is far from efficient.

In other words, the client can send and receive online information to/from the server via an IP address set as the default, not an IP address enabling the most rapid sending/reception of the online information to/from the server. For this reason, particularly, for real-time protocol-based online information such as voice information, the client cannot send and receive a packet with the information along an optimum path.

### SUMMARY OF THE INVENTION

Therefore, the present invention has been made in view of the above problem, and it is an object of the present invention to provide a system and method for exchanging online information along an optimum path, wherein a client with a plurality of Internet protocol addresses can send and receive the online information to/from a server along the optimum path.

In accordance with one aspect of the present invention, the above and other objects can be accomplished by the provision of a system for exchanging online information along an optimum path in a client/server system, the client/server system including a client having a plurality of Internet protocol (IP) addresses for sending and receiving the online information over an Internet network, and a server connected to the client via a router, wherein the client is adapted for sending first information about its IP address for access to the server, to the server upon accessing the server, determining whether it employs a private network, from first acknowledgement information sent from the server in response to the first information, sending second information about its valid IP addresses to the server upon determining that it employs the private network, and exchanging the online information with the server via an IP address providing the optimum path to the server, on the basis of second acknowledgement information sent from the server in response to the second information; and the server is adapted for comparing the access IP address contained in the first information sent from the client with an IP address of the client for actual access to the server via the router to determine whether the two IP addresses are the same, sending the determined result as the first acknowledgement information to the client and then sending the second acknowledgement information to all of the valid IP addresses contained in the second information, sent from the client in response to the first acknowledgement information, such that the client detects the optimum path to the server.

In accordance with another aspect of the present invention, there is provided a method for exchanging online information along an optimum path in a client/server system, the client/server system including a client having a plurality of Internet protocol (IP) addresses for sending and receiving the online information over an Internet network, and a server connected to the client via a router, the method comprising the steps of a), by the server, determining whether the client employs a private network and sending the determined result to the client; b), by the client, sending information about its valid IP addresses to the server if the result determined at the step a) indicates that the client employs the private network; c), by the server, sending acknowledgement information to all of the valid IP addresses contained in the information sent at the step b); d), by the client, detecting an IP address at which the acknowledgement information sent from the server has arrived earliest, and then recognizing that the detected IP address is one for the provision of the optimum path to the server; and e), by the client, exchanging the online information with the server via the IP address detected at the step d).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a conventional method for exchanging online information over an online network on the basis of a static network address translation (NAT);

FIG. 2 is a block diagram illustrating a conventional method for exchanging online information over an online network on the basis of a dynamic NAT;

FIG. 3 is a block diagram illustrating a conventional method for exchanging online information over an online network on the basis of masquerading;

FIG. 4 is a block diagram showing the construction of a system for exchanging online information along an optimum path in accordance with the present invention;

FIG. 5 is a block diagram showing formats of packets sent and received in a method for exchanging online information along an optimum path in accordance with the present invention; and

FIG. 6 is a flowchart illustrating the method for exchanging the online information along the optimum path in accordance with the present invention.

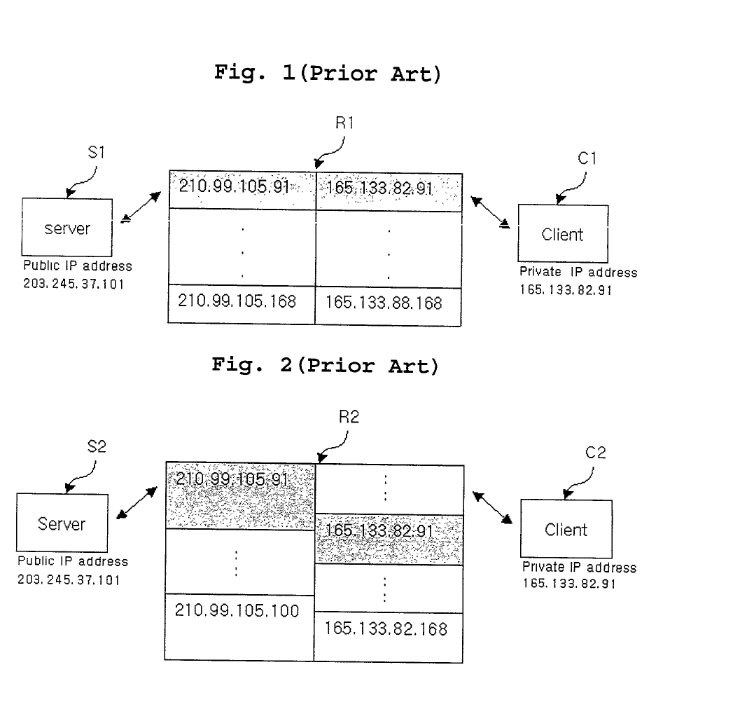

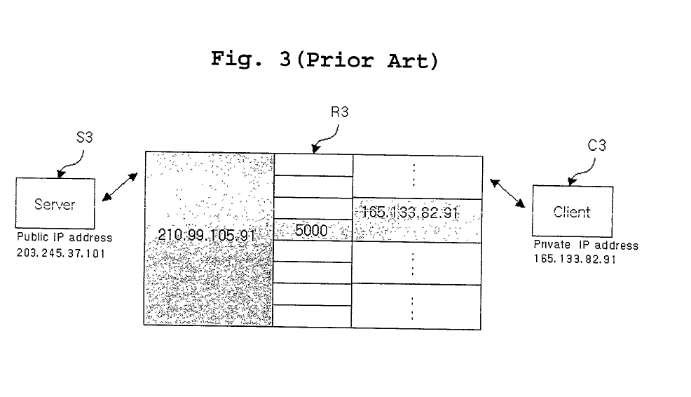

### DETAILED DESCRIPTION OF THE PREFERRED EMBODIMENTS

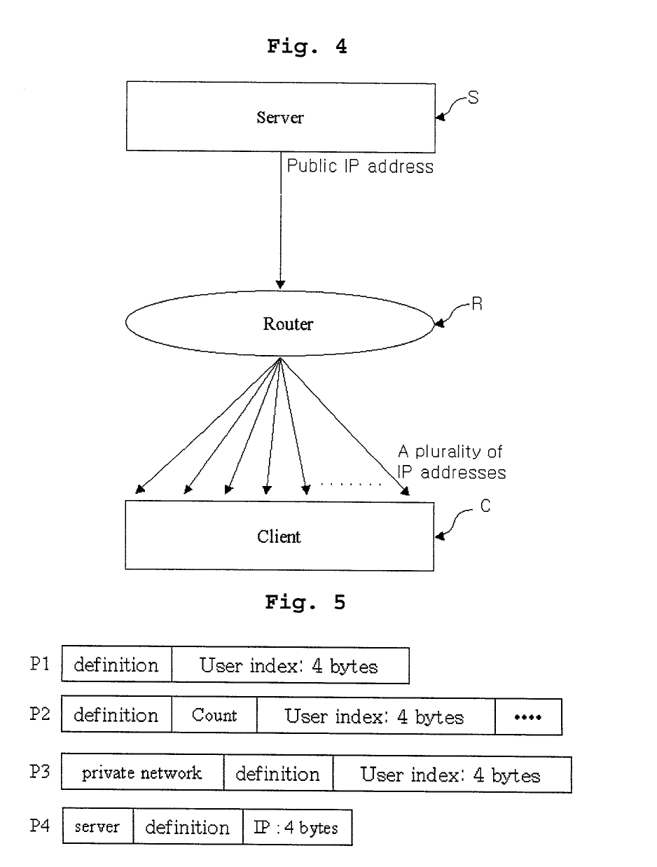

With reference to FIG. 4, there is shown in block form the construction of a system for exchanging online information along an optimum path in accordance with the present invention. As shown in this drawing, the present online information exchange system comprises a router R, a server S, and a client C for sending and receiving online information to/from the server S through the router R.

The client C may employ a plurality of private or public Internet protocol (IP) addresses. Provided that the client C employs a private IP address, it will use a private network. In this case, the private IP address of the client C is translated into a public IP address by an NAT function of the router R upon accessing the external server S.

The server S exchanges online information with the client C connected thereto via the router R.

In that a plurality of IP addresses are employable, the client C can be connected to the server S via a public IP address, proxy server or private IP address. Further, because a plurality of IP addresses are employable, a separate IP address may exist for the provision of an optimum path to the server S, other than an IP address for the client's initial access to the server S.

Therefore, in order to detect the IP address providing the optimum path, the present online information exchange system first determines whether the client C employs a private network and then detects the IP address for the provision of the optimum path only where the client C employs the private network.

Provided that the client C employs no private network, it will access the server C via a public IP address. In this case, it is common practice that the optimum path is based on the public IP address.

The server S receives first information about an IP address of the client C for initial access to the server S, sent from the client C, compares the initial access IP address with an IP address of the client C for actual access to the server S via the router R, and determines from the compared result whether the client C employs a private network.

In case the client C employs the private network, the server S sends first acknowledgement information to the client C to notify it of the fact that it employs the private network. In response to the first acknowledgement information from the server S, the client C sends second information about its valid IP addresses and actually used IP address to the server S.

Thereafter, the server S sends second acknowledgement information to all of the IP addresses contained in the second information sent from the client C. In the present embodiment, the server S loads the sent second acknowledgement information with information about the IP address for actual access via the router R. In FIG. 4, the server S is shown to send the second acknowledgement information to the client C. The server S sends the second acknowledgement information to all IP addresses in an IP list of the client C.

The client C detects an IP address at which the second acknowledgement information sent from the server S has arrived earliest, recognizes that the detected IP address is one for the provision of the optimum path to the server S, and then exchanges online information with the server S via the detected IP address.

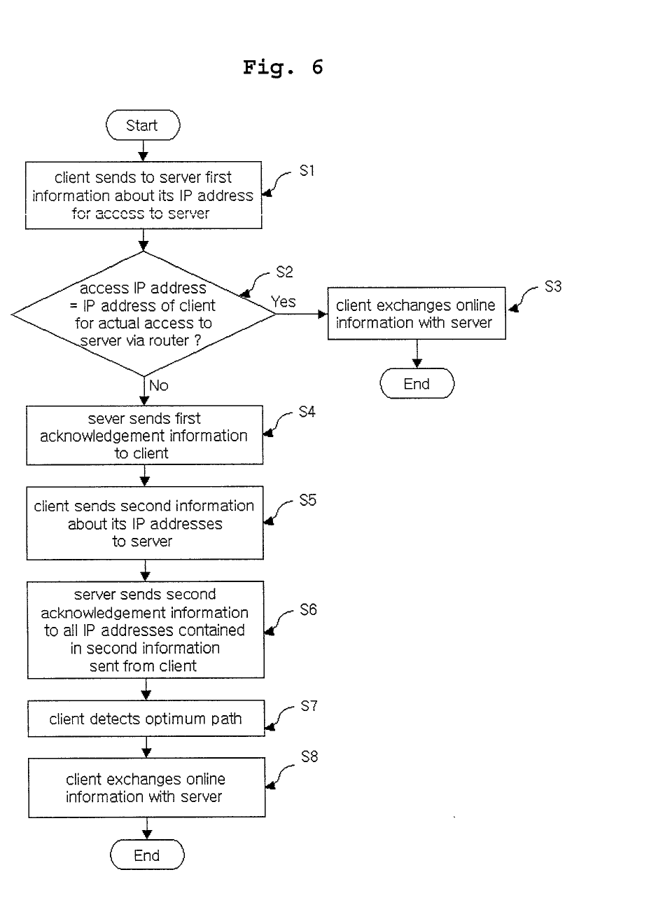

A detailed description will hereinafter be given of the operation of the optimum path-based online information exchange system with the above-stated construction in accordance with the present invention with reference to FIG. 6.

FIG. 6 is a flowchart illustrating a method for exchanging online information along an optimum path in accordance with the present invention.

At the first step S1, the client C sends to the server S first information about its IP address for access to the server S.

At the second step S2, the server S compares the access IP address sent from the client C with an IP address of the client C for actual access to the server S via the router R to determine whether the two IP addresses are the same, and then determines from the compared result whether the client C employs a private network.

In the case where it is determined at the above second step S2 that the client C employs no private network, it is signified that the client C employs a public IP address. As a result, the client C exchanges online information with the server S via the employed public IP address at the third step S3.

Where the client C is determined to employ the private network at the above second step S2, it is indicated that the client C employs a proxy server or private IP address. As a result, the sever S sends first acknowledgement information to the client C to notify it of such a fact at the fourth step S4.

At the fifth step S5, the client C sends second information about its valid IP addresses and actually used IP address to the server S in response to the first acknowledgement information from the server S, in order to detect an optimum path to the server S.

At the sixth step S6, the server S sends second acknowledgement information to all of the IP addresses contained in the second information sent from the client C.

At the seventh step S7, the client C detects an IP address at which the second acknowledgement information sent from the server S has arrived earliest. It is recognized that the detected IP address is one for the provision of the optimum path to the server S. In this manner, the client C detects the optimum path to the server C.

At the eighth step S8, the client C exchanges online information with the server S via the detected IP address providing the optimum path to the server S.

FIG. 5 is a block diagram showing formats of packets sent and received in the optimum path-based online information exchange method in accordance with the present invention.

In FIG. 5, “P1” indicates a packet sent at the above fourth step, which is composed of a definition statement for defining the packet, and a 4-byte user index statement for identifying a client sending the packet later over a private network. For example, private IP addresses of two or more clients may be transformed into the same public IP address by masquerading. In this case, the use of the user index statement makes it possible to distinguish a client attempting to exchange online information with the server S, from the clients with the same public IP address.

“P2” indicates a packet sent at the above fifth step, which is composed of a definition statement, a count statement for counting the number of IP addresses, an IP statement for representing an IP address, and a repeated sequence thereof.

“P3” indicates a packet sent at the above sixth step, which is composed of a private network statement for indicating the use or not of a private network, a definition statement and a user index statement. The user index statement of P3 makes it possible for the server S to distinguish a specific client from other clients sending various information.

“P4” indicates a packet sent at the above seventh step, which is composed of a server statement for indicating that this packet is sent from the server, a definition statement, and an IP statement for representing an IP address of a specific client for actual access to the server. In the present embodiment, the server S loads the second acknowledgement information with information about an IP address of the client C for actual access to the server S. The client C detects an IP address at which the second acknowledgement information has arrived earliest. Therefore, the detected IP address is the very one for the provision of the optimum path to the server S. In this manner, the client C detects the optimum path to the server C.

As described above, a client with a plurality of IP addresses detects an optimum path most efficient for the sending of a packet to a server in order to exchange online information of the packet with the server.

For a client whose private IP address is transformed into a public IP address by masquerading, information regarding a used port as well as the private IP address is sent to the server. Accordingly, a client having a plurality of private IP addresses transformed into one public IP address can detect a port providing an optimum path to the server, so that it can exchange online information with the server along the optimum path.

As apparent from the above description, the present invention provides a system and method for exchanging online information along an optimum path, wherein a client that has a plurality of IP addresses and desires to exchange the online information with a server with a public IP address over an external Internet network can detect an IP address providing the optimum path for access to the server, from among the plurality of IP addresses. Therefore, the client can send and receive the online information to/from the server along the optimum path, resulting in an increase in information exchange rate and an improvement in the quality of the online information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for exchanging online information along an optimum path in a client/server system, said client/server system including a client having a plurality of Internet protocol (IP) addresses for sending and receiving the online information over an Internet network, and a server connected to said client via a router, said method comprising the steps of:
a), by said server, determining whether said client employs a private network and sending the determined result to said client;
b), by said client, sending information about its valid IP addresses to said server if said result determined at said step a) indicates that said client employs the private network;
c), by said server, sending acknowledgement information to all of said valid IP addresses contained in said information sent at said step b);
d), by said client, detecting an IP address at which said acknowledgement information sent from said server has arrived earliest, and then recognizing that the detected IP address is one for the provision of the optimum path to said server; and
e), by said client, exchanging the online information with said server via said IP address detected at said step d).

2. The online information exchange method as set forth in claim 1, wherein said step a) includes the steps of:
a-1), by said client, sending to said server information about its IP address for access to said server;
a-b 2), by said server, comparing said access IP address with an IP address of said client for actual access to said server via said router to determine whether the two IP addresses are the same, and then determining from the compared result whether said client employs the private network; and
a-3), by said server, sending the determined result to said client.

3. The online information exchange method as set forth in claim 1, wherein said step a) includes the step of, by said server, sending to said client user index information for identification of said information sent from said client after said step a) is performed; and
wherein said step b) includes the step of, by said client, sending said user index information sent at said step a) back to said server such that said server recognizes that said client is the very one connected thereto at said step a).

4. The online information exchange method as set forth in claim 1, wherein said step b) includes the step of, by said client, recognizing that it is connected to said server via a public IP address, if said result determined at said step a) indicates that said client employs no private network, and then gaining access to said server via said public IP address to exchange the online information with said server.

5. The online information exchange method as set forth in claim 1, wherein said step b) includes the step of, by said client, sending information about its actually used IP address to said server together with said information about its valid IP addresses.

6. The online information exchange method as set forth in claim 1 or claim 2, wherein said step b) includes the step of, by said client, sending information about its used port to said server together with said information about its valid IP addresses; and
wherein said step a-1) includes the step of, by said client, sending said information about its used port to said server together with said information about its IP address for access to said server.

7. A system for exchanging online information along an optimum path in a client/server system, said client/server system including a client having a plurality of Internet protocol (IP) addresses for sending and receiving the online information over an Internet network, and a server connected to said client via a router, wherein said client is adapted for sending first information about its IP address for access to said server, to said server upon accessing said server, determining whether it employs a private network, from first acknowledgement information sent from said server in response to said first information, sending second information about its valid IP addresses to said server upon determining that it employs the private network, and exchanging the online information with said server via an IP address providing the optimum path to said server, on the basis of second acknowledgement information sent from said server in response to said second information; and
said server is adapted for comparing said access IP address contained in said first information sent from said client with an IP address of said client for actual access to said server via said router to determine whether the two IP addresses are the same, sending the determined result as said first acknowledgement information to said client and then sending said second acknowledgement information to all of said valid IP addresses contained in said second information, sent from said client in response to said first acknowledgement information, such that said client detects the optimum path to said server.

8. The online information exchange system as set forth in claim 7, wherein said client is further adapted for detecting an IP address at which said second acknowledgement information from said server has arrived earliest, recognizing that the detected IP address is one for the provision of the optimum path to said server and then exchanging the online information with said server via the detected IP address.

9. The online information exchange system as set forth in claim 7, wherein said client is further adapted for sending information about its actually used IP address to said server together with said second information about its valid IP addresses.

10. The online information exchange system as set forth in claim 7, wherein said client is further adapted for sending information about its used port to said server together with said first information about its IP address for access to said server and said second information about its valid IP addresses.
